(19) United States
(12) Patent Application Publication
(10) Pub. No.: US 2025/0068994 A1
(43) Pub. Date: Feb. 27, 2025

(54) SOFTWARE OFFER DEVELOPMENT ORGANIZATIONAL FRAMEWORK AND TRACKING SYSTEM AND PROCESS

(71) Applicant: Insight Direct USA, Inc., Chandler, AZ (US)

(72) Inventors: John Christopher Broad, Wake Forest, NC (US); Joseph Raymond Flynn, Hackettstown, NJ (US)

(21) Appl. No.: 18/237,461

(22) Filed: Aug. 24, 2023

(51) Int. Cl. G06Q 10/0631

(52) U.S. Cl. CPC G06Q 10/06311

(57) ABSTRACT

A method of organizing a software offering development process is disclosed herein that includes selecting a framework reflective of an extent to which the software offering is to be developed and providing, based on the selected framework, a list of development roles needed to complete the software offering development process. The method can also include designating individuals to fill each of the development roles within the list of development roles and, in response to the selection of the framework, creating the software offering development process based at least in part on the selected framework with the process being divided into multiple phases of development with each phase having multiple tasks automatically assigned to at least one of the individuals depending on the individuals designated to fill each of the development roles. The method can further include creating, based on the selected framework, a development schedule for the offering.

### FIELD OF THE INVENTION

The disclosure relates generally to the development of a computer software offering and, more specifically, to a framework and system for organizing and tracking the offer development process.

### BACKGROUND

The development of an offering (e.g., a software program, solution, and/or other project) can include many phases having multiple tasks performed by various individuals. Depending on the offering being developed, these phases, tasks, and individuals can change during the development process and from one offering to the next, thereby requiring modification of the process (e.g., the phases, tasks, and/or individuals) during development. However, each offering development process is different, so it is difficult to create an organizational and tracking system for development processes that works for all types of offerings. Additionally, each development process can take extensive time and effort by a project lead and/or others to determine what tasks are required to complete development of the offering, schedules for when those particular tasks need to be completed, and what individuals need to perform those tasks to complete development of the offering.

### SUMMARY

A method of organizing a software offering development process can include selecting a framework reflective of an extent to which the software offering is to be developed and providing, based on the selected framework, a list of development roles needed to complete the software offering development process. The method can also include designating individuals to fill each of the development roles within the list of development roles and, in response to the selection of the framework, creating the software offering development process based at least in part on the selected framework with the process being divided into multiple phases of development with each phase having multiple tasks automatically assigned to at least one of the individuals depending on the individuals designated to fill each of the development roles. The method can further include creating, based on the selected framework, a development schedule having deadlines by which each of the tasks within the development phases is to be completed.

A system for organizing a development of a software offering can include a framework defining a process by which the development of the software offering is to proceed with the process having multiple phases of development which each phase having multiple tasks, a list of development roles to which individuals associated with the development are assigned with a number and types of development roles being based on the selected framework, and an assignment module, which includes at least a portion of a computer processor, configured to automatically assign at least one of the multiple tasks of the process to at least one of the individuals based on the development role to which the individual is assigned. The system can further include a scheduling module, which includes at least a portion of the computer processor. configured to automatically create a development schedule having deadlines by which each of the multiple tasks within the development phases is to be completed by the assigned individual.

### BRIEF DESCRIPTION OF THE DRAWINGS

FIG. 1 is an example of an offering development system for organizing and tracking an offering development process.

FIG. 2 is an example flow chart of an offering development process.

FIG. 3 is an example dialog box for prompting the selection of a development framework.

FIG. 4 is an example dialog box for prompting the designation of individuals associated with the offering development process to development roles.

FIG. 5 is an example folder list stored on digital memory with each folder corresponding to a phase of the offering development process.

FIG. 6 is an example dashboard for an individual showing multiple offerings in development and the status of those offering development processes.

While the above-identified figures set forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The processes and systems described herein can include a software program/system that provides a flexible framework for organizing and tracking the development of a computer software offering. The processes and systems can take the offering from the intake phase through completion of development of the offering. The systems and related processes automatically prompt decision makers to make decisions at critical points during the offering development process and, dependent upon those decisions, create a development framework within which the offering development process proceeds. The framework, which depends on the type of offering being developed, can automatically determine the number and type of phases of the development process as well as the tasks within those phases. The systems can also automatically prompt the designation of individuals to fill development roles associated with the development of the offering. Based on the designation of those individuals, the systems can automatically assign tasks to at least one of the individuals as well as set deadlines for those specific individuals/teams of individuals to complete those tasks. Further, the systems can create folders for each phase of the offering development, with those folders potentially containing templates specific to the phase depending on the selected framework. The systems can also create online communication channel(s), group(s), and/or other communication avenues to enable easier communication between some or all individuals designated to work on the offering development.

The development framework is highly flexible, allowing for any changes to the offering development process through the modification of any aspects of the phases, tasks, deadlines, etc. to better suit the offering that is being developed. The framework can be modified to add, alter, and/or delete phases, tasks, schedules, deadlines, communication channels, folders, files, templates, assignments/designations of individuals, and/or any other information and/or processes regarding the offering. The systems can also create a dashboard for each individual associated with the offering development, and the dashboard can display the tasks and the individual(s) responsible for completing the tasks, the status of each task, the phase each task is within, where in the development process the offering is, and/or other information regarding the offering and/or other/multiple offerings. The development framework is flexible to accommodate any different type of offering development process (having any number of phases, tasks, etc.) without requiring the alteration of the process to fit within the framework and/or tracking system. The systems prompt decision makers for information and/or decisions so that the offering development process does not stall out.

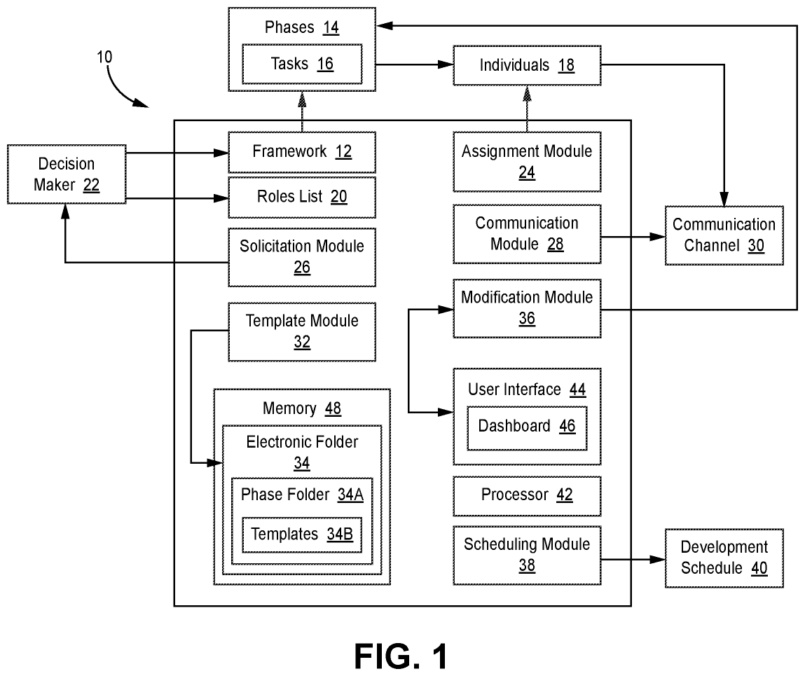

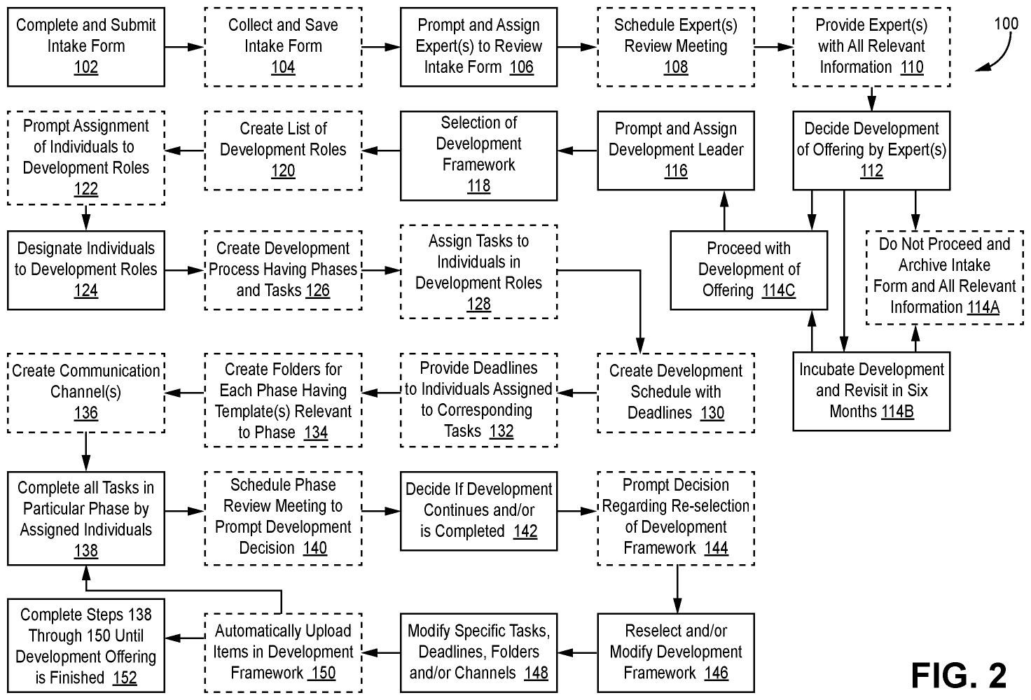

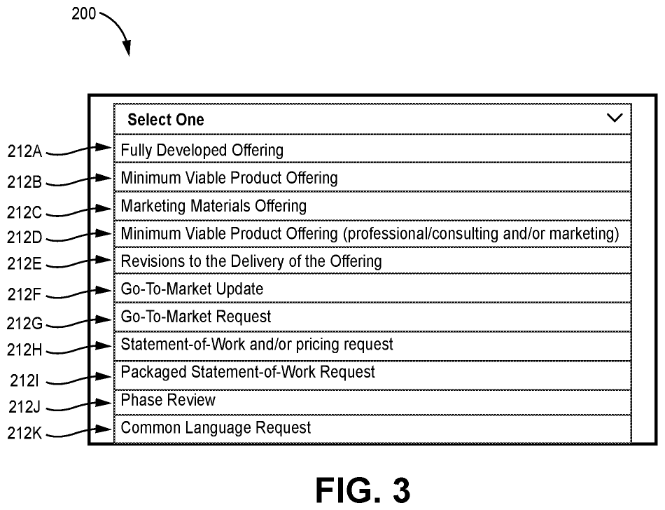

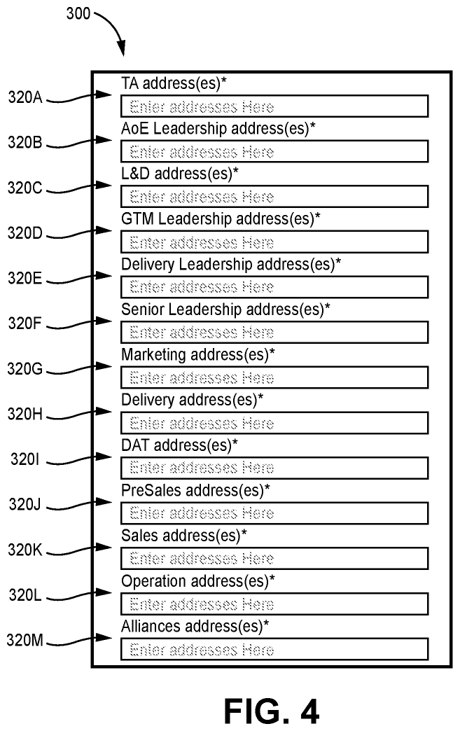

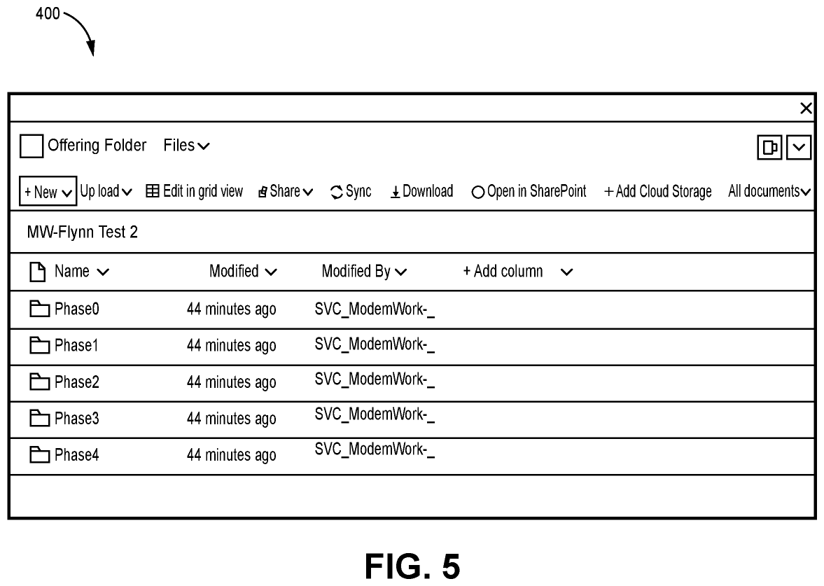

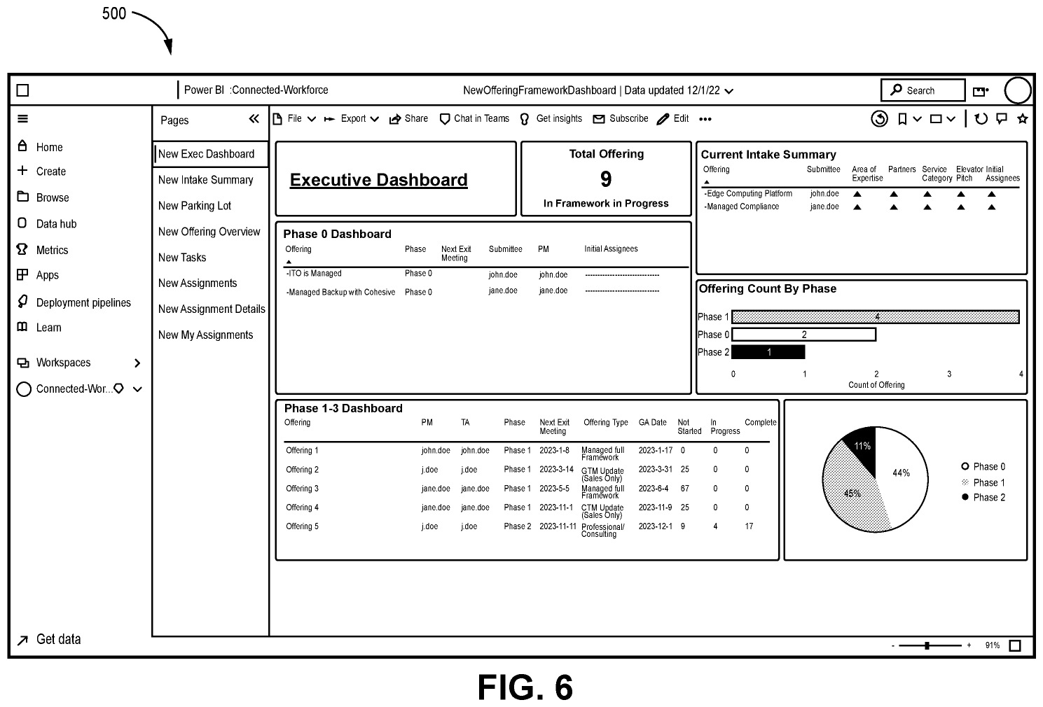

FIG. 1 is an example of offering development system 10 for organizing and tracking offering development process 100. FIG. 2 is an example flow chart of offering development process 100. FIG. 3 is an example dialog box 200 for prompting the selection of a development framework. FIG. 4 is an example dialog box 300 for prompting the designation of individuals associated with offering development process 100 to development roles. FIG. 5 is an example folder list 400 reflecting storage media contents, with each folder corresponding to a phase of offering development process 100. FIG. 6 is an example dashboard 500 for an individual showing multiple offerings in development and the status of those offering development processes 100. FIGS. 1-6 are described together.

Offering development system 10 is shown in FIG. 1, while offering development process 100 is shown in FIG. 2. Offering development system 10 can include development framework 12 for designating phases 14 having tasks 16 to be completed by individuals 18 as selected, designated, and/or recorded in development role list 20 by decision maker 22, which can be a development leader, expert, and/or another person associated with the development of the offering. Offering development system 10 can also include assignment module 24 for assigning tasks 16 to individuals 18, solicitation module 26 for prompting decision maker 22 to take various actions regarding the development of the offering, and communication module 28 for formulating/creating at least one communication channel 30 to allow individuals 18 to communicate regarding the development of the offering. Offering development system 10 can also include template module 32 for creating at least one electronic folder 34 providing storage/organization for files regarding each of phases 14 via phase folders 34A, with each of the phase folders 34A potentially containing templates 34B relevant to that particular phase 14 associated with the corresponding phase folder 34A. Offering development system 10 can also include modification module 36 for allowing a user to introduce new phases 14 and/or tasks 16, delete phases 14 and/or tasks 16, and/or alter an action that needs to be completed to complete a task 14 within a phase 16 (among other capabilities). Modification modules 36 can enable the modification/alteration of any of the other components and/or processes of system 10 and/or process 100. Offering development system 10 can further include scheduling module 38 for setting out development schedule 40 (e.g., creating development schedule 40 depending on the selected development framework 12), with development schedule 40 having deadlines by which each of tasks 16 is to be completed by individuals 18. Offering development system 10 can further include computer processor 42, user interface 44 (with dashboard 46), and memory 48. Offering development process 100 can use, and offering development system 10 can include, any computer software and/or hardware for performing the functions described herein.

Offering development system 10 (and the disclosed offering development process 100 shown and described with regards to FIG. 2) can include other steps, components, modules, configurations, and/or features not expressly disclosed herein that are suitable for enabling the selection and modification of a development framework, prompting (e.g., soliciting) information and/or decisions from decision maker(s) 22, setting development schedule 40 (that can include deadlines, schedule various meetings, etc.), creating various support components (e.g., communication channel 30, electronic folder 34, dashboard 46, etc.), and/or other functions. For example, offering development system 10 can include any number of digital/electronic storage media (e.g., memory 48) for storing data/information, any number of computer processors (e.g., processor 42) for performing tasks/instructions with regards to offering development system 10. communication via wired or wireless communication methods between components of offering development system 10 and/or between other components, systems, individuals, etc. distant from offering development system 10, and/or other components. Offering development system 10 is described herein as including one or multiple “modules,” which can be any hardware and/or software for performing the tasks, functionality, and/or capabilities described herein with regards to those modules. These “modules” can be instantiated in dedicated hardware, and/or can be defined functionally and use shared hardware.

Additionally, offering development system 10 can be a discrete assembly or be formed by one or more elements capable of individually or collectively implementing the functionalities described herein. In some examples, offering development system 10 can be implemented as a plurality of discrete circuitry subassemblies. In some examples, one or all components of offering development system 10 can include or be implemented at least in part on a smartphone or tablet, among other options. In some examples, one or all components of offering development system 10 can include and/or be implemented as downloadable software in the form of a mobile application. The mobile application can be implemented on a computing device, such as a personal computer, tablet, or smartphone, among other suitable devices. One or all components of offering development system 10 can be considered to form a single computing device even when distributed across multiple component computing devices. Any components of offering development system 10 can use machine learning to establish and refine functions/techniques for performing the processes described herein.

Offering development system 10 can include a configuration in which one, some, or all of the functions described herein are performed by different components. Offering development system 10 can include various components for performing the above functions (as well as other functions described in this disclosure), such as processor 42, user interface 44, and/or memory 48.

Offering development system 10 (and/or the components of system 10, such as framework 12, roles list 20, assignment module 24, solicitation module 26, communication module 28, template module 32 modification module 26, and/or scheduling module 28) can include one or multiple computer/data processors 42 (also referred to as “processor 42”). In general, processor 42 can include any or more than one of a processor, a microprocessor, a controller, a digital signal processor (DSP), an application specific integrated circuit (ASIC), a field-programmable gate array (FPGA), or other equivalent discrete or integrated logic circuitry. Processor 42 can perform instructions stored within storage media, such as memory 48 (or located elsewhere), and/or processor 42 can include storage media such that processor 42 is able to store instructions and perform the functions described herein. Additionally, processor 42 can perform other computing processes described herein, such as the functions performed by any of the components of offering development system 10.

Offering development system 10 (and/or the components of system 10, such as framework 12, roles list 20, assignment module 24, solicitation module 26, communication module 28, template module 32 modification module 26, and/or scheduling module 28) can also include memory 48. Memory 48 is configured to store information and, in some examples, can be described as a computer-readable storage medium. Memory 48, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 46 is a temporary memory. As used herein, a temporary memory refers to a memory having a primary purpose that is not long-term storage. Memory 48, in some examples, is described as volatile memory. As used herein, a volatile memory refers to a memory that that the memory does not maintain stored contents when power to memory 46 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on offering development system 10 to temporarily store information during program execution.

Memory 48, in some examples, also includes one or more computer-readable storage media. Memory 48 can be configured to store larger amounts of information than volatile memory. Memory 48 can further be configured for long-term storage of information. In some examples, memory 48 includes non-volatile storage elements. Examples of such non-volatile storage elements can include, for example, magnetic hard discs, optical discs, floppy discs, flash memories, cloud storage media, or forms of electrically programmable memories (EPROM) or electrically erasable and programmable (EEPROM) memories. As shown in the example of offering development system 10, memory 48 can store electronic folder(s) 34 having phase folders 34A with templates 34B that are relevant to the particular phase 14 of the phase folder 34A, can store and/or provide organization for files regarding each of phases 14, and/or other information, data, and/or instructions associated with the offering.

Offer development system 10 can also include user interface 44. User interface 44 can be an input and/or output device and enables an operator to control operation, modification, view of data, etc. of offer development system 10 and/or dashboard 46 (described below). For example, user interface 44 can be configured to receive inputs from an operator and/or provide outputs. User interface 44 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, and/or other type of device for facilitating input and/or output of information in a form understandable to users and/or machines.

The other components of offering development system 10 are described below with regards to offering development process 100 (also referred to herein as “process 100”) in FIG. 2 and dialog boxes 200-500 in FIGS. 3-6. Process 100 can include other steps not expressly disclosed herein, can include the steps in other orders than those shown in FIG. 2, or can include the performance of one or multiple steps multiple times. For example, steps 138 through 150 can be performed multiple times until completion of development of the offering (step 152).

Moreover, while process 100 is described herein as being performed by or in association with offering development system 10, process 100 can be performed by another system having the necessary capabilities and/or functionality to perform the steps described herein. the illustrative embodiment of process 100 shown in FIG. 2, the steps/boxes having a dotted outline may be performed automatically or manually by offering development system 10, while the steps/boxes having a solid outline can be performed, aided by offering development system 10, by individuals associated with process 100, such as decision maker 22, individuals 18 assigned to one or multiple development roles, initiators that conceived the idea for the offering and/or completed an intake form detailing a proposed offering, and/or other individuals not expressly disclosed herein. Additionally, process 100 can be performed partially or entirely in a digital environment by and/or within offering development system 10, such as by processor 42 and saved in memory 48. The components of system 10 are described herein in conjunction with the discussion of process 100 below.

To begin offering development process 100, one or multiple initiators can perform step 102, which is to complete and submit an intake form to offering development system 10. In one example, the initiators, who can be any individuals, conceive of an offering that they would like to be developed (e.g., the development can be by a team, company, etc. using offering development system 10 and/or offering development process 100). For example, the offering can be a program that compresses an image file into a smaller file size without much reduction in image quality. In step 102, the initiators would formulate and complete an intake form that details the proposed offering and can include a scope of work, potential market for the offering, and/or any other information relevant to the proposed offering. Then, step 102 can include submitting the intake form to offering development system 10. This submittal can be through an online portal, by sending the intake form via email, via a dialog box and/or user interface 44 of system 10, or by other methods not expressly disclosed herein.

After step 102 is performed to complete and submit the intake form, process 100 can include step 104, which can be to collect and save the intake form 104. Step 104 can be performed automatically by offering development system 10 in response to the completion and submittal of the intake form (step 102). The intake form can be received by system 10 and collected by, for example, processor 42 and saved in, for example, memory 48. Step 104 can also be carried out with regards to additional information regarding the proposed offering as provided by the initiators and/or others. For example, step 102 can include submitting a marketing study as to the market viability of the proposed offering, and step 104 can include collecting that marketing study, associating it with the intake form for the proposed offering, and saving the marketing study in storage media for system 10 (e.g., memory 48).

Upon completion and/or submittal of the intake form (step 102), system 10 can perform step 106, which can include prompting the assignment of one or multiple experts to review the intake form (and related materials). An individual, such as an initiator or decision maker 22, can assign one or multiple experts to review the intake form. The prompting of the assignment of the experts can be performed automatically by system 10 in response to the submittal of the intake form, or the prompting of the assignment of the experts can be performed by an individual associated with system 10, process 100, and/or the proposed offering. In one example, the experts are assigned automatically based upon a technical area of the proposed offering as specified in the intake form. In another example, the experts are assigned by being selected by the initiators from a list during the submittal of the intake process (during step 102). The prompting of the assignment of the experts can be performed by solicitation module 26, which can prompt (e.g., send an email, a notice, and/or any other solicitation) any individual suitable for selecting the experts. When the experts are assigned to review the intake form in step 106, system 10 can also associate the experts with the proposed offering so that the experts are listed accordingly in a list of roles (e.g., roles list 20) and are provided with relevant information, deadlines, scheduling items, etc. regarding the duties of the experts with regards to the proposed offering. For example, the experts can be assigned via assignment module 24 and added to roles list 20.

After or at the time the experts are assigned (step 106), process 100 can include step 108, which is scheduling a meeting for the experts to review the intake form (and other materials) for the proposed offering. System 10 can be configured to review a calendar for each of the experts and automatically schedule a meeting at an available time for the experts to meet, review, and discuss the proposed offering. System 10 can be configured to schedule the meeting a specific amount of time after the submittal of the intake form (i.e., after the completion of step 102), such as scheduling the meeting at least seven days after the submittal of the intake form. Step 108 can be performed by scheduling module 38 and/or any other components of system 10.

Process 100 can also include step 110, which is to provide the experts with all relevant information relating to the proposed offering. Step 110 can be performed automatically in advance of the meeting scheduled in step 108, can be performed automatically in response to the initiator(s) signaling that they have finished submitting information regarding the proposed offering (e.g., via checking a box by some other manner), or in response to another prompt, such as in response to a request by the experts. Step 110 can include retrieving the relevant information from, for example, memory 48 and providing that information to the experts through a variety of methods, including by sending the information via email, providing an access key to the experts that allows for access to the relevant information, or other methods.

Then, process 100 can have step 112, which is deciding the development of the offering by the experts, which can be decision makers 22 as shown in FIG. 1. Step 112 can be performed before, during, or after the meeting of the experts scheduled in step 108. If a decision by the experts regarding the development of the offering is not entered into system 10, system 10 (specifically, for example, solicitation module 26) can prompt the experts/decision makers 22 to decide and/or enter the decision into system 10 so that system 10 can take the next steps set out in process 100. In the example shown in FIG. 2, the experts can decide one of three development paths for the proposed offering, with those paths being shown in steps 114A, 114B, and 114C.

The first development path decided by the experts in step 112 is set out in step 114A, which is not to proceed with development of the proposed offering. If this development path is chosen, step 114A can include archiving the intake form and all relevant information. This information can be saved, for example, in memory 48 for later reference/searching by individuals that may want to look through unsuccessfully proposed offerings. This archiving in step 114A can be performed automatically by system 10 in response to the experts decision not to proceed with development of the proposed offering. System 10 can perform the archiving in step 114A automatically in response to the experts signaling that the proposed offering will not be developed by retrieving the intake form and other relevant information from storage media, such as memory 48, and moving that information to another location/folder (i.e., an archive in another location).

The second development path decided by the experts in step 112 is set out in step 114B, which is to incubate development of the offering (i.e., table the decision on how/whether to proceed with development of the offering). If this development path is chosen, step 114B can include revisiting the proposed offering in, for example, six months. System 10 can be configured to then reperform one or multiple of steps 106-112 by assigning new experts, scheduling a meeting to review the proposed offering, providing those experts with all relevant information regarding the proposed offering, and prompting the experts to decide the development path for the proposed offering. The incubation and revisiting of the proposed offering in step 114B can be configured to be performed at any time after the decision to incubate/table the decision on how/whether to proceed with development of the offering and can include a variety of other capabilities. For example, step 114B can include a reminder to the experts six months after tabling the decision to revisit the proposed offering and make a final decision. After incubating and revisiting the proposed offering, step 114B can be repeated and the decision can be tabled again for a designated amount of time. Alternatively, the experts can decide not to develop the proposed offering and process 100 proceeds to step 114A (archiving all information regarding the proposed offering). Finally, the experts can decide to proceed with development of the proposed offering and process 100 proceeds to step 114C.

The third development path decided by the experts in step 112 can be to proceed with further development of the offering, which is set out in step 114C and can include continuing with steps 116-152 of process 100.

After deciding to proceed with development of the offering by the experts (step 114C), process 100 can include prompting the assignment of and assigning a development leader, which is set out in step 116. The development leader can be the individual in charge of the development of the offering, for example decision maker 22. The prompting of the assignment of the development leader can be performed automatically by system 10 in response to the decision to go forward with development of the offering, or the prompting of the assignment of the development leader can be performed by an individual associated with system 10, process 100, and/or the offering (such as the experts). In one example, the development leader is assigned automatically based upon a technical area of the offering as specified in the intake form and/or as specified by the experts. In another example, the development leader is selected by the experts from a list of potential development leaders. The prompting of the assignment of the development leader can be performed by solicitation module 26, which can prompt (e.g., send an email, a notice, and/or any other solicitation) anyone with the necessary expertise and authority to assign the development leader. When the development leader is assigned in step 116, system 10 can also associate the development leader with the offering so that the development leader is listed accordingly in a list of roles (e.g., roles list 20) and are provided with relevant information, deadlines, scheduling items, etc. regarding the duties of the development leader with regards to the development process of the offering. For example, the development leader can be assigned via assignment module 24 and added to roles list 20.

Process 100 can include step 118 to prompt and process the selection of the development framework 12 for the development process and for aiding in completion of development of the offering. The selection of framework 12 in step 118 can be performed via dialogue box 200 shown in FIG. 3. As with other steps of process 100, the prompting of the selection of framework 12 can be performed automatically in response to, for example, the assignment of the development leader (or in response to another action of process 100) and can be performed by, for example, solicitation module 26 to decision maker 22 (e.g., the development leader). The development framework 12 selected in step 118 is reflective of the extent to which the offering is to be developed, and the framework 12 that is selected can be dependent upon the intake form that has details about the offering. In the example shown in dialogue box 200 in FIG. 3, the following frameworks 12 can be selected regarding the development of the offering: fully developed offering 212A, minimum viable product offering 212B, marketing materials offering 212C, minimum viable product offering regarding professional/consulting and/or marketing materials 212D, revisions to the delivery of the offering 212E (e.g., an update to the offering schedule), go-to-market update 212F (e.g., an update regarding the sales and/or marketing of the offering), go-to-market request 212G, statement-of-work and/or pricing request 212H, packaged statement-of-work request 212I, phase review 212J, and/or common language request 212K (which can include a request regarding the standardized words used to categorize the name of offerings within the systems). System 10 can include other options of frameworks 12 than those shown in dialogue box 200 in FIG. 3, and/or the selected framework 12 can be altered and/or changed at any time during process 100 as described below with regards to step 146, step 148, and/or other steps of process 100. The selection of framework 12 can be performed by the development leader or by another individual associated with process 100. This individual can be decision maker 22 as shown in FIG. 1 and described herein.

In another example, step 118 (the selection of framework 12) can be performed before step 116 (the assignment of the development leader), and the assignment of the development leader can be dependent upon the type of framework 12 that is selected by decision maker 22 to set out the development process of the offering (e.g., a development leader that is more familiar with the fully developed offering framework may be selected).

Depending on the selected framework 12 set out in step 118, process 100 can include step 120, which is creating a list of development roles (shown in FIG. 1 as roles list 20). The number and types of development roles in roles list 20 can be based upon the selected framework 12. For example, the selection of a minimum viable product framework 12 in step 118 would likely have different (and potentially fewer) development roles than if a fully developed offering framework 12 was selected. One or multiple development roles in role list 20 can have tasks 16 associated with the development role such that the individual assigned to that specific role is responsible for completing those tasks 16. The development roles that are associated with each type/process of framework 12, and the tasks 16 associated with each type of development role of roles list 20, can be saved in memory 48 (or another component of system 10) and formulated by system 10 (e.g., by processor 42) in response to the selection of framework 12. The roles list 20 for the selected framework 12 can be provided to decision maker 22 (e.g., the development leader) in response to the selection of framework 12.

After the list of development roles is formulated (step 120), process 100 can include step 122, which is to prompt assignment/designation of individuals to the development roles in roles list 20. The prompting of the assignment/designation of individuals to the development roles can be performed automatically by system 10 in response to the selection of framework 12 in step 118, or the prompting of the assignment/designation of individuals to development roles can be performed by an individual associated with system 10, process 100, and/or the offering (such as the experts or another decision maker 22). In one example, the development leader (e.g., decision maker 22) is prompted by system 10 and/or process 100 to designate the individuals to the development roles. In another example, another individual associated with development of the offering is prompted. The prompting of the assignment of the development roles can be performed by solicitation module 26, which can prompt (e.g., send an email, a notice, and/or any other solicitation) anyone with the necessary expertise and authority to assign the development roles. In one example, the prompting of the assignment/designation of individuals to the development roles is performed by displaying dialogue box 300, shown in FIG. 4, for decision maker 20 (e.g., displaying via user interface 44 or by another method and/or component). Dialogue box 300 includes roles list 20 having a variety of development roles that need to be assigned/designates for the offering depending on selected framework 12 that is reflective of the extent to which the offering is to be developed in process 100. Dialogue box 300 can be dynamic in that the type and number of development roles making up role list 20 in dialogue box 300 can change depending on the type of framework 12 selected during step 118. As shown in dialogue box 300 in FIG. 4, the development roles in roles list 20 can include, for example, TA 320A, AoE leadership 320B, L&D 320C, GTM leadership 320D, delivery leadership 320E, senior leadership 320F, marketing 320G, delivery 320H, DAT 320I, presales 320J, sales 320K, operations 320L, and/or alliances 320M. Dialogue box 300, and roles list 20, can include other development roles not expressly disclosed herein.

In step 124, decision maker 22 (or another individual associated with the development of the offering) can assign/designate individuals to fill the development roles in roles list 20. Decision maker 22 can designate/assign each role through a variety of methods, including simply making roles list 20 with each development role corresponding to an individual. In another example, decision maker 22 can designate individuals for each development role listed in dialogue box 300, shown in FIG. 4, depending on selected framework 12 with system 10 effectuating the assignment of those individuals. For example, system 10 can accept the assignment of individuals to the development roles and automatically notify those individuals of their assigned roles via an email or another communication.

Decision maker 22 can simply type an individual's name and/or email address into the space provided in dialogue box 300 for each role, or dialogue box 300 can be configured to provide a drop-down list of potential individuals to fill the specific development role. The individuals in the drop-down list can be pulled from a list created prior to the beginning of development of the offering based on individual skill, experience, etc. and can be dependent upon framework 12 selected in step 118 or upon other factors. In another configuration, process 100 and system 10 can be configured to automatically assign/designate the individuals for the development roles depending on the selected framework 12 and/or other factors. For example, John Doe can be automatically designated as user experience lead for each offering development in which the selected framework 12 is for a fully developed offering, while James Smith can be automatically designated as the user experience lead for each offering development in which the selected framework 12 is for a minimum viable product offering.

Process 100 and system 10 can be configured such that multiple individuals/decision makers 22 are responsible for performing step 124 in designating/assigning the individuals to the development roles in roles list 20. In such a situation, multiple individuals may have access to dialogue box 300 and/or roles list 20 to make the designation/assignment. Moreover, dialogue box 300 can be configured to allow for multiple individuals to be assigned to the same development role (e.g., system 10 can allow for decision maker 22 to add roles to roles list 20 in dialogue box 300 or generally in system 10 shown in FIG. 1 and/or assign multiple individuals to the same role). Process 100 and system 10 are flexible, allowing for the alteration of any of the elements, components, and/or steps of the development process before and/or during execution of process 100, such as the alteration of the number and/or type of development roles in roles list 20. This alteration can be performed using modification module 36, as shown in FIG. 1, or other components of system 10.

In response to the assignment of the development leader (step 116), the selection of the development framework 12 (step 118), and/or the designation of individuals for development roles (step 124), process 100 and/or system 10 can perform one or a number of the following steps automatically organize/formulate the offering development process, provide tools for the individuals monitoring and/or working on the development of the offering, and/or track the progress of the offering development.

Process 100 can include step 126, which is creating, formulating, or otherwise defining development process having phases 14 and tasks 16. The development of the offering can be divided into one or numerous development phases 14. The number of phases 14, the tasks 16 within each of phases 14, individuals 18 assigned to complete those tasks 16, the review process of each phase 14 and/or each task 16, and/or other configurations can be dependent upon the selected framework 12. Phases 14 can divide the development of offering into any number of discrete subparts having any number of tasks 16 that, when completed by individuals 18, result in the completion of the corresponding phase 14. System 10 can be configured to automatically divide the offering development process into phases 14 and/or tasks 16 based upon the selected framework 12 (e.g., frameworks 212A-212K), or step 126 can be performed by decision maker 22 or any other individuals 18 associated with the offering development. For example, if the framework 12 selected in step 118 is to be a fully developed offering (e.g., framework 212A), then process 100 (and system 10) can be configured to automatically select that the offering development will include five phases 14 (denoted in dialogue box 400 in FIG. 5 as phases 0-4) with, for example, phase 0 having seven tasks 16, phase 1 having thirteen tasks 16, phase 2 having twenty-seven tasks 16, phase 3 having twenty-five tasks 16, and phase 4 having thirty-eight tasks 16. The division of the development offering process into phases 14 and tasks 16 is known to one of skill in the technical field. However, process 100 and system 10 can be configured to perform this division automatically depending on the selected framework 12. Details regarding the division of the offering development can be saved by system 10, such as in memory 48, for use upon the selection of framework 12. For example, system 10 can store all development processes (e.g., how the development process is to be divided into phases 14 and/or tasks 16) for any of the framework options, and system 10 can then automatically formulate the specific development offering process in response to the particular framework 12 being selected for the development offering (e.g., by selecting one of frameworks 212A-212K in dialogue box 300).

Process 100 can also include step 128, which is assigning tasks 16 to individuals 18 in corresponding development roles. Step 128 can include placing those tasks 16 into the proper phase 14, or this can be performed as part of step 126. Tasks 16 can be assigned to individuals 18 based upon the skills, experience, etc. of each individual 18, or tasks 16 can be assigned to at least one of the individuals 18 automatically depending on the individuals designated/assigned to the development roles in roles list 20. Step 128 can also include automatically notifying individuals 18 of their assigned tasks 16 via an email or another communication, including showing the assigned tasks 16 on dashboard 46 (described below). The tasks 16 that are assigned to the individuals designated for each of the development roles in step 124 can be dependent on framework 12 selected in step 118, and how those tasks 16 are assigned can be saved by system 10 for application/use once step 118 and/or step 124 is completed. The assignment of tasks 16 to individuals 18 can be performed by assignment module 24 of system 10 (as shown in FIG. 1) or by another component of system 10.

Process 100 can include step 130, which is creating and/or formulating development schedule 40 that sets out the timeline by which phases 14, tasks 16, and/or the development of the offering are to be completed. Formulating development schedule 40 can include forming deadlines, setting dates/times for meetings to discuss various aspects of the development of the offering, setting dates/times for prompts regarding any decisions that need to be made regarding the development of the offering (e.g., prompting decision maker 22, by solicitation module 26, to decide whether to continue development after the completion of the first phase 14 of the offering development), and/or other information regarding the timeline of the development of the offering. Step 130 can be performed by scheduling module 38 or another component of system 10.

The development schedule 40, deadlines, meetings, etc. can be displayed by dashboard 46, which is shown in FIG. 6. The example dashboard 46 shown in FIG. 6 is displaying information for decision maker 22, which can be a development leader and/or another high-level individual/executive overseeing (or at least aware of) nine offerings in the development process. Formulating development schedule 40 can be dependent upon selected framework 12 and/or other information regarding the offering, such as the marketability, regulatory aspects, etc. The development schedule 40 can be modified before or during the development process by one or multiple individuals 18 or others, such as decision maker 22 (e.g., the development leader). Additionally, the development schedule 40 can be adjusted during the development process depending on the timeliness of completion of phases 14 and/or tasks 16. Process 100 and system 10 can assign a development schedule 40 to the offering development based on the selected framework 12. Each potential framework 12 (e.g., frameworks 212A-212K) can have a corresponding development schedule 40 (the framework 12 and corresponding development schedule 40 can be stored by system 10). Thus, upon selection of framework 12, process 100 and/or system 10 (e.g., scheduling module 38) can automatically create/formulate development schedule 40. Process 100 and system 10 are flexible and allows for alteration of any of the timelines, deadlines, meeting schedules, etc. of development schedule 40. This alteration can be performed using modification module 36, as shown in FIG. 1, at any time before and/or during process 100.

Process 100 can include step 132 to provide deadlines to individuals 18 assigned to corresponding tasks 16. As with step 128 in assigning and notifying individuals 18 of tasks 16 for which they are responsible completing, system 10 and/or process 100 can include automatically notifying individuals 18 of deadlines by which their assigned tasks 16 are to be completed via an email or by another communication method, such as by displaying the deadlines on dashboard 46 (shown in FIG. 6) for each individual 18. Additionally, process 100 and/or system 10 can add the deadlines to the calendar of the individual 18 (such as the individual's Outlook and/or Microsoft Teams calendar). Step 132 can include altering these deadlines (potentially by modification module 36) by anyone associated with the offering development (e.g., decision maker 22, individuals 18, the development leader, or another person), and the deadlines can by altered/updated depending on the completion of phases 14 and/or other tasks 16. For example, the deadlines for all tasks in the second phase can be moved up ten days depending on the early completion of all tasks 16 in the first phase. In another example, the deadlines for the corresponding tasks 16 can be dependent upon decisions made by decision maker 22 (e.g., the development leader) regarding the offering development, such as the decision to change the selected framework 12 during the offering development process (e.g., in step 146).

System 10 and/or process 100 can perform and/or include step 134, which is to create and/or formulate electronic folder 34 having one or multiple phase folders 34A corresponding to phases 14 of the offering development. Dialogue box 400, shown in FIG. 5, includes electronic folder 34 having example phase folders 34A for phases 0-4, with each of those phase folders 34A corresponding to one phase 16 and each of those phase folders 34A potentially having templates 34B. Electronic folder 34 can be in memory 48 of system 10 or stored at another location. Each of the phase folders 34A for each of the phases 14 can include templates 34B relevant to tasks 16 that are to be completed in the corresponding phase 14 for which the phase folder 34A is designated. Templates 34B can include any documents, programs, code, databases, lists, and/or information that may be useful to individuals 18 working on tasks 16 within the specific phase 14. While described herein as a “template,” templates 34B do not need to be templates that tasks 16 can build upon, but rather can be any information that is useful to individuals 18. Templates 34B can be stored by system 10, such as in memory 48 or in another repository of templates 34B, and templates 34B can be added to phase folders 34B by template module 32 depending on tasks 16 assigned to the particular phase 14 and/or dependent upon the individuals responsible for the tasks 16. Additionally, template module 32 can be configured to create new templates and add those templates 34B to electronic folder 34. Process 100 an include adding a similar template 34B to multiple phase folders 34A if such action would be useful to individuals 18 working on tasks 16 within the specific phase 14. Process 100 can also include the creation of other folders for storing and/or organizing information and/or elements for the development of the offering. For example, in-progress and/or completed components/parts of the offering can be stored and/or worked on within electronic folder 34.

Process 100 can also include step 136, which is creating and/or formulating one or multiple communication channels 30 to allow for communication between individuals 18 regarding the development of the offering. Communication channels 30 can include any method that allows for communication between individuals associated with the offering development, such as an email list, a chat group, or other communication methods. Communication channels 30 can include one communication group for the entire offering development process (e.g., for all individuals 18 working on and/or associated with the development of the offering), one group for each phase 14 of the offering development, one group for each task 16, and/or multiple groups having various purposes as is desired by individuals 18 associated with the offering development. Individuals 18 that are in each of the communication channels 30 can be dependent upon the selected framework 12, the individuals' development roles in roles list 20, and/or other factors.

Process 100 can then include step 138, which is completing all tasks 16 in the first phase 14 by individuals 18 assigned to those tasks 16. Step 138 can be performed by one or multiple individuals 18, and the completion of tasks 16 can be performed by the corresponding individuals 18 assigned to those tasks 16. The progress of tasks 16 can be tracked by system 10 and/or shown via user interface 44 (e.g., dashboard 46). Upon completion of one or multiple task 16, process 100 and/or system 10 can be configured to notify others associated with the offering development, such as decision maker 22 (e.g., the development leader), individuals assigned to tasks 16 that depend upon the completion of the task, and/or others. As described below, step 138 can be performed multiple times corresponding to each phase 14 of the offering development process.

In response to the completion of all tasks 16 within a particular phase 14 (step 138), process 100 can include step 140, which is to schedule a phase review meeting (also referred to herein as a “phase end meeting”) and/or to prompt a development decision. After the completion of each phase 14, it may be necessary to revisit the development of the offering to determine if development should continue. Thus, process 100 and system 10 can include and/or perform the scheduling of a meeting for decision maker(s) 22 (e.g., development leaders and any other individuals 18 with input and/or decision-making power) to discuss and/or decide on whether to continue development of the offering, any changes that should be made to the offering or process 100, and/or anything else associated with the offering. Process 100 and system 10 can prompt the scheduling of this meeting and/or prompt decision maker 22 to decide whether to continue the offering development process. The prompting of the meeting and/or decision on the future of the development of the offering can be performed automatically by system 10 in response to the completion of the particular phase 14 (e.g., the completion of all tasks 16 in that particular phase 14), or the prompting of the meeting and/or decision on the future of the development of the offering can be performed by an individual associated with system 10, process 100, and/or the offering (such as individuals 18 or another decision maker 22). The prompting can be performed by solicitation module 26, which can prompt (e.g., send an email, a notice, and/or any other solicitation) anyone with the necessary expertise and authority (e.g., decision maker 22 or another associated with the offering development) to decide whether to continue with development of the offering. As described below, step 140 can be performed multiple times: once at the end of each completed phase 14.

Process 100 can include step 142, which is to decide if development of the offering will continue. Step 142 can be performed by decision maker 22 (e.g., the development leader), by one or multiple individuals 18, or anyone else associated with the offering and/or the development of the offering. The decision of whether to continue development of the offering can be dependent upon the progress of the offering, the timeliness of the completion of tasks 16 and/or phases 14 as compared to deadlines and/or schedules, market forces, the availability of individuals 18 to work on future tasks 16 and/or future phases 14 (e.g., those tasks 16 and/or phases 14 that have yet to be completed), the costs of the development up to that point and the estimated costs to continue development of the offering, and/or other factors. As described below, step 142 can be performed multiple times at the completion of each phase 14. Additionally, step 142 can be performed at any point during process 100, allowing decision maker 22 to decide whether to continue or discontinue development of the offering when necessary.

Process 100 can include step 144, which is prompting a decision regarding the reselection of the development framework 12 that was selected in step 118. After the completion of each phase 14 or at other times, process 100 and system 10 can be configured to send a reminder to decision maker 22 or another individual(s) with authority regarding whether the development of the offering should continue as is (e.g., conforming to framework 12 selected in step 118) or whether the offering development should continue by adhering to a different framework 12. The prompting of the decision on the reselection of framework 12 can be performed automatically by system 10 in response to the completion of the phase 14 (e.g., the completion of all tasks 16 in that particular phase 14), or the prompting of the reselection of framework 12 can be performed by an individual associated with system 10, process 100, and/or the offering (such as individuals 18 or another decision maker 22). The prompting of the reselection of framework 12 can be performed by solicitation module 26, which can solicit (e.g., send an email, a notice, and/or any other solicitation) anyone with the necessary expertise and authority to reselect framework 12. In one example, the prompting of the reselection of framework 12 is performed by redisplaying dialogue box 200, shown in FIG. 3, for decision maker 20 (e.g., displaying via user interface 44 or by another method and/or component).

Step 146 can be performed by reselecting and/or modifying development framework 12. The reselection of framework 12 and/or the decision to modify the selected framework 12 can be performed by decision maker 22 (e.g., the development leader), by one or multiple individuals 18, or anyone else associated with the offering and/or the development of the offering. In one example, the reselection of framework 12 and/or modify the selected framework 12 can be performed using dialogue box 300 to reselect any of frameworks 212A-212K. Step 146 can also include modifying the selected development framework 12 to include more or less phases 14 than those in the preconfigured frameworks described with regards to step 118. As with the decision to continue or discontinue with the development of the offering, the decision as to the reselection of framework 12 and/or modify the selected framework 12 can be dependent upon the progress of the offering, the timeliness of the completion of tasks 16 and/or phases 14 as compared to deadlines and/or schedules, market forces, the availability of individuals 18 to work on future tasks 16 and/or future phases 14 (e.g., those tasks 16 and/or phases 14 that have yet to be completed), the costs of the development up to that point and the estimated costs to continue development of the offering, and/or other factors. As with steps 138-144 described above, step 146 can be performed multiple times and/or at any point during process 100.

If, in step 146, the framework 12 is changed to a different framework 12 than that which was selected in step 118 and/or if it is desired to modify the framework 12 to include a different number of phases 14 and/or tasks 16, process 100 can include step 148. At step 148, aspects of process 100 are modified. Such aspects can include phases 14, tasks 16, the individual selected for the development leader (e.g., decision maker 22), individuals 18 assigned to development roles in roles list 20, the tasks 16 that individuals 18 are responsible for completing, development schedule 40, deadlines, phase folders 34A, templates 34B, communication channels 30, and/or other inputs, parameters, or rules of process 100. Process 100 and system 10 are highly flexible with all components, elements, steps, etc. able to be modified by, for example, modification module 36 of system 10 as shown in FIG. 1. The modifications made to process 100 and/or system 10 in step 148 can be entered via user interface 44 and/or other components, and the modifications can be shown and/or communicated to those associated with the development of the offering via a variety of methods, including displaying the modifications and/or changed information (e.g., the new/altered tasks 16, the new/altered communication channels 30, the new/altered development schedule 40) on dashboard 46, emailing the updated information to individuals 18, and/or via another communication. The modifications in step 148 can be performed by anyone associated with the development of the offering, such as decision maker 22 (e.g., the development leader), individuals 18, or others with expertise and/or authority.

If the selected framework 12 is modified (such as alterations to phases 14 and/or tasks 16), process 100 can include step 150, which is to update/alter the framework options stored by system 10 from which framework 12 can be selected. For example, selected framework 12 can be the fully developed offering framework that includes five phases 14. However, during step 146, decision maker 22 (e.g., the development leader) can decide that the fully developed offering framework should instead have eight phases with tasks being reorganized among the eight phases and include new tasks. This modification can be effectuated in step 146 and/or step 148 for the current development of the offering. It may be desirable to have this new organization of the fully developed offering framework be the default framework such that any future selections of the fully developed offering framework in step 118 and/or step 146 will have eight phases with the reorganized and additional tasks. Step 150 can include automatically updating the stored frameworks with the new organizations/configurations as specified in step 146 and/or as specified at another time and/or location by any individual associated with the development of the current offering or the development of past or future offerings. Moreover, step 150 can be performed by an individual using user interface 44 and/or other components of system 10, or step 150 can be performed through various other methods using other components not expressly disclosed herein as being a part of system 10. Process 100 and system 10 can include saving the newly modified framework by overwriting the previous framework, by creating a new framework while maintaining the previous, unmodified framework, or by any other methods. The newly modified framework can be saved, along with the other frameworks, by system 10, for example, in memory 48.

Process 100 can then include step 152, which is repeating some or all of steps 138-150 until the development of the offering is finished (or until the development of the offering is discontinued). For example, if framework 12 has five phases 14 that organize the development of the offering, steps 138-150 may be performed five times (for the five phases) for the development to be completed. However, some of steps 138-150 may not be performed for each phase 14, so steps 138-150 may be performed any number of times until development of the offering is completed (or discontinued).

System 10 can include dashboard 46, and process 100 can include the use of dashboard 46 to complete a number of steps 102-152. Dashboard 46 can be part of user interface 44, or dashboard 46 can be a separate component from user interface 44 or any of the other components of system 10. Dashboard 46 can be configured to be personal to the user such that the information displayed by dashboard 46 is dependent upon and relevant to the user. Dashboard 46 can be configured to visually display, for example, a list of tasks 16 that are assigned to the user/individual 18 for the user/individual 18 to complete. In another example, dashboard 46 can be configured to display the total offerings in development that the user/individual 18 is working on or otherwise associated with. Other information as to the offerings can be displayed, such as the number of offerings and the status of those offerings, a pie chart giving the percentage of offerings that are in each phase of the development process, development schedule 40 of one or multiple offering developments, deadlines for any or all tasks 16, communication channels 30 to which the user/individual 18 belongs, and/or other information. The information displayed by dashboard 46 can be modified by the user/individual 18 or another individual associated with system 10 and/or process 100. Dashboard 46 can be configured to enable the modification of any of the components, steps, elements, etc. of system 10 and/or process 100, such as modifying phases 14. tasks 16, the individual selected for the development leader (e.g., decision maker 22), individuals 18 assigned to development roles in roles list 20, the tasks 16 that individuals 18 are responsible for completing, development schedule 40, deadlines, phase folders 34A, templates 34B, and/or communication channels 30.

Process 100 and system 10 as described herein can provide a flexible framework for organizing and tracking the development of a computer software offering. Process 100 and system 10 can take the offering from the intake phase through completion of development of the offering. Process 100 and system 10 can automatically prompt decision makers 22 to make decisions at critical points during the offering development process and, dependent upon those decisions, create a development framework 12 within which the offering development process 100 proceeds. The framework 12, which depends on the type of offering being developed, can automatically determine the number and type of phases 14 of the development process as well as the tasks 16 within those phases 16. Process 100 and system 10 can also automatically prompt the designation of individuals 18 to fill development roles in roles list 20 with the development roles being associated with the development of the offering. Based on the designation of those individuals 18, process 100 and system 10 can automatically assign the tasks 16 to at least one of the individuals 18 as well as set deadlines (via development schedule 40) for those specific individuals/teams of individuals to complete those tasks 16. Further, process 100 and system 10 can create electronic folders 34 having phase folders 34A for each phase 14 of the offering development, with those phase folders 34A potentially containing templates 34B specific to the phase 14 depending on the selected framework 12. Process 100 and system 10 can also create one or multiple online communication channels 30 that can potentially contain group(s) and/or other communication avenues to enable easier communication between some or all individuals 18 designated to work on the offering development.

The development framework 12 is highly flexible, allowing for any changes to the offering development process through the modification any aspects of phases 14, tasks 16, deadlines, etc. to better suit the offering that is being developed. The framework 12 can be modified to add, alter, and/or delete phases 14, tasks 16, schedules, deadlines, communication channels 30, folders 34, files, templates 34B, assignments/designations of individuals, and/or any other information and/or processes regarding the offering. Process 100 and system 10 can also create and/or include dashboard 46 for each individual 18 and/or decision maker 22 associated with the offering development, and the dashboard 46 can display the tasks 16 and the individual(s) 18 responsible for completing the tasks 16, the status of each task 16, the phase 14 each task 16 is within, where in the development process 100 the offering is, and/or other information regarding the offering and/or other/multiple offerings. The development framework 12 is flexible so as to accommodate any different type of offering development process (having any number of phases 14, tasks 16, etc.) without requiring the alteration of the process to fit within the framework 12 and/or tracking system. Process 100 and system 10 can prompt decision makers 22 for information and/or decisions so that the offering development process does not stall out.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of organizing a software offering development process, the method comprising:
selecting a framework reflective of an extent to which the software offering is to be developed;
providing, based on the selected framework, a list of development roles needed to complete the software offering development process;
designating individuals to fill each of the development roles within the list of development roles;
in response to the selection of the framework, creating the software offering development process based at least in part on the selected framework, the process being divided into multiple phases of development with each phase having multiple tasks automatically assigned to at least one of the individuals depending on the individuals designated to fill each of the development roles; and
creating, based on the selected framework, a development schedule having deadlines by which each of the tasks within the development phases is to be completed.

2. The method of claim 1, further comprising:
in response to the selection of the framework, creating an electronic folder for each of the phases based at least in part on the selected framework, the electronic folder having a template for use by the individuals with the template within each phase depending on the phase and the selected framework.

3. The method of claim 1, wherein the selection of the framework is based on an intake form having details about the software offering that is to be developed by the software offering development process.

4. The method of claim 3, further comprising:
in response to a submittal of the intake form, scheduling a meeting for a decision maker to review the intake form; and
prompting the decision maker to select the framework in response to completion of the meeting.

5. The method of claim 1, further comprising:
in response to the selection of the framework, prompting the selection of a development leader which in turn designates the individuals to fill each of the development roles within the list of development roles.

6. The method of claim 1, wherein the extent to which the software offering is to be developed is one of a fully developed software offering, a minimum viable product software offering, a marketing materials software offering, a minimum viable product software offering for marketing, revisions to a delivery of the software offering, a go-to-market update for the software offering, a go-to-market request for the software offering, a statement-of-work having a pricing request for the software offering, a packaged statement-of-work request, a phase review, and a common language request.

7. The method claim 1, further comprising:
in response to the completion of all tasks within a phase, prompting a decision maker to determine whether to continue the software offering development process.

8. The method of claim 1, further comprising:
in response to the designation of the individuals to fill each of the development roles within the list of development roles, automatically creating an online communication channel that is accessible by each of the individuals.

9. The method of claim 1, further comprising:
after selection of the framework, modifying the tasks within at least one of the phases depending on the software offering that is to be developed.

10. The method of claim 9, wherein the modification of the tasks includes at least one of: introducing new tasks within at least one of the phases, deleting tasks within at least one of the phases, and altering an action that needs to be completed to complete the task within at least one of the phases.

11. The method of claim 9, further comprising:
in response to the modification of the tasks requiring the designation of individuals needed to fill additional development roles, prompting the designation of those individuals.

12. The method of claim 1, further comprising:
adding tasks to an individual dashboard that shows all of the tasks assigned to that individual depending on the individuals designated to fill each of the development roles and the selected framework.

13. The method of claim 1, further comprising:
automatically scheduling a phase end meeting at the completion of each phase, the phase end meeting including a decision maker; and
prompting the decision maker to determine whether to continue the software offering development process.

14. The method of claim 13, further comprising:
prompting the decision maker to determine whether to continue with the selected framework or to select a different framework within which the software offering is to be developed going forward.

15. A system for organizing a development of a software offering, the system comprising:
a framework defining a process by which the development of the software offering is to proceed, the process having multiple phases of development which each phase having multiple tasks;
a list of development roles to which individuals associated with the development are assigned with a number and types of development roles being based on the selected framework;
an assignment module, which includes at least a portion of a computer processor, configured to automatically assign at least one of the multiple tasks of the process to at least one of the individuals based on the development role to which the individual is assigned; and
a scheduling module, which includes at least a portion of the computer processor, configured to automatically create a development schedule having deadlines by which each of the multiple tasks within the development phases is to be completed by the assigned individual.

16. The system of claim 15, further comprising:
a template module, which includes at least a portion of the computer processor, configured to create an electronic folder within storage media for each of the phases with the electronic folder having at least one template for use by the individuals assigned to work on tasks within that phase, the at least one template within each phase being based on the phase and the selected framework.

17. The system of claim 15, further comprising:
a solicitation module, which includes at least a portion of the computer processor, configured to prompt at least one decision maker to select the framework defining the process and to assign individuals for each development role in the list of development roles.

18. The system of claim 15, further comprising:
a communication module, which includes at least a portion of the computer processor, configured to automatically create, in response to the assigning of individuals to fill each of the development roles in the list of development roles, an online communication channel accessible by each of the individuals.

19. The system of claim 15, further comprising:
a modification module, which includes at least a portion of the computer processor, configured to modify at least one task of the multiple tasks after selection of the framework by a user,
wherein the modification of the at least one task includes at least one of: introducing new tasks within at least one of the phases, deleting tasks within at least one of the phases, and altering an action that needs to be completed to complete the task within at least one of the phases.

20. The system of claim 15, further comprising:
a dashboard configured to visually display a list of tasks that are assigned to the user for the user to complete.
